(19) United States
(12) Patent Application Publication
(10) Pub. No.: US 2010/0100910 A1
(43) Pub. Date: Apr. 22, 2010

(54) Broadband Mobile Satellite Vehicle (MSV)

(76) Inventor: Bernard Frances Pettingill, Palm Beach Gardens, FL (US)

Correspondence Address: Bernard Pettingill, #93 Sandbourne Lane, Palm Beach Gardens, FL, 33418, US

(21) Appl. No.: 12/254,606

(22) Filed: Oct. 20, 2008

(51) Int. Cl. H04N 7/18

(52) U.S. Cl. 725/75

(57) ABSTRACT

Multi-mobile satellite vehicle (MSV) video/audio broadband teleconferencing system with one to one or one to multiple broadband location capabilities. The mobile satellite vehicle (MSV) utilizes multiple internal video/audio monitors, a wireless broadband network and/or a broadband satellite communication system. The primary video/audio source (mobile satellite vehicle (MSV)) will receive all video/audio signals, which are generated by other broadband sources whether broadband mobile satellite vehicle (MSV) systems, broadband water based systems, broadband air based systems or broadband land based systems. The mobile satellite vehicle (MSV) receives the broadband video/audio signals, which are displayed onto internal video/audio monitors. In addition, internal video/audio cameras (PTZ—pan tilt zoom) records and captures signals, which are then transmitted via broadband wireless network(s) or broadband satellite to fixed or mobile broadband conference locations. This conference can also be saved/burned to a disk(s), stored on an internal MSV hard drive(s) or stored on a portable external hard drive(s). Finally, these broadband signals are transmitted through the broadband satellite system in real time, utilizing a broadband satellite dish or through a wireless broadband network surrounding the MSV.

### FIELD OF THE INVENTION

This invention relates generally to a broadband mobile communication system, which is utilized to facilitate face-to-face communication even though the individuals/groups are customarily separated by large distances (not at the same location) and may be on land, sea or air.

### BACKGROUND OF THE INVENTION

Mobile satellite vehicle (MSV) will provide a broadband communication link between and among multiple parties at various remote environment(s) and location(s). Work in a comfortable and luxurious mobile office (MSV) from any local or remote location(s). Avoid travel, don't take the airline, the train or auto and avoid the need to be onsite for a conference.

These capabilities are achieved by exploiting a variety of hardware, software and networking technologies never assembled in this unique manner, which preserves the quality and integrity of broadband video/audio communication at a significantly reduced investment (time/money) compared to what it would normally cost to duplicate this setting.

### SUMMARY OF THE INVENTION

This invention of broadband satellite communication(s), monitor(s)/computer(s), hardware/software and related technologies is integrated in a sophisticated approach to facilitate broadband video/audio conferencing without the need to meet face to face. Broadband herein refers to speeds greater than 1.50 M/sec transfer rate upload and 4.09 M/sec transfer rate download.

The present invention has integrated amplified speakers and high sensitivity microphones, which provide hands free communication through the internal monitor/computer system and ultimately out through the broadband satellite system. In addition, the MSV also provides for phone/fax utilization through the broadband satellite system.

The present invention has a computer system with a desk-top icon for one-click deployment and initiation of broadband satellite communication with an automated satellite tracking system. The computer system also captures broadband video/audio signals and burns (DVD's to a multi-drive burner)/stores the media on an internal MSV hard drive or on a portable external hard drive.

The present invention has internal power generation sources via vehicle engine, generator or battery back-up to provide continuous power generation and avoid an interruption of power once linked via broadband communicating with other broadband mobile satellite vehicle (MSV) systems, broadband water based systems, broadband air based systems or broadband land based systems. Mobile satellite vehicle (MSV) also utilizes two air conditioning systems to provide continuous cooling, thus avoiding hardware overheating as well as an environment that is comfortable to on site conferencing personnel.

In order to illustrate how the present invention may be implemented and operated, an example of preferred embodiment will be described having features applicable to the aforementioned mobile satellite vehicle (MSV). It is to be understood that this embodiment is merely illustrative, and is not to be considered to be exclusive so as to bind the scope of the invention. This invention may be adapted for other applications or uses having more or less hardware, software and operating features and/or a combination thereof.

Consider the following scenario involving access from a remote site (legal or medical facility) to a courtroom. The focus of the scenario revolves around an “Expert” being questioned by a public defender who simultaneously is being viewed by the jury via broadband communication. The expert is unable to attend the on-site questioning due to the inconvenience of transporting the large volume of charts, equipment, supplies and time needed to demonstrate the evidence to the jury. Utilizing the aforementioned mobile satellite vehicle (MSV) via broadband, the jury and judge can view all pertinent verbal information as well as non-verbal communication to any and all questions. To duplicate this scenario in the court room setting, it would costs tens of thousands of dollars to the taxpayer and an inordinate amount of time and other resources. Resources are more efficiently and effectively utilized with the right technology at the right time, i.e. the mobile satellite vehicle (MSV) embodiment below.

### BRIEF DESCRIPTION OF THE DRAWINGS

The preferred and alternative embodiments of the present invention are described in detail with references.

FIGS. 1 and 9 is an overview diagram illustrating the satellite vehicle (MSV) with two aerial views.

### DETAILED DESCRIPTION OF THE PREFERRED EMBODIMENT

These and other features, aspects and advantages of the present invention will be better understood with reference to a preferred embodiment, which is illustrated in the drawings. The illustrated embodiment is merely exemplary and is not intended to define the entire scope of the present invention. The drawings of the illustrated arrangement comprise two main figures with several smaller figures also discussed.

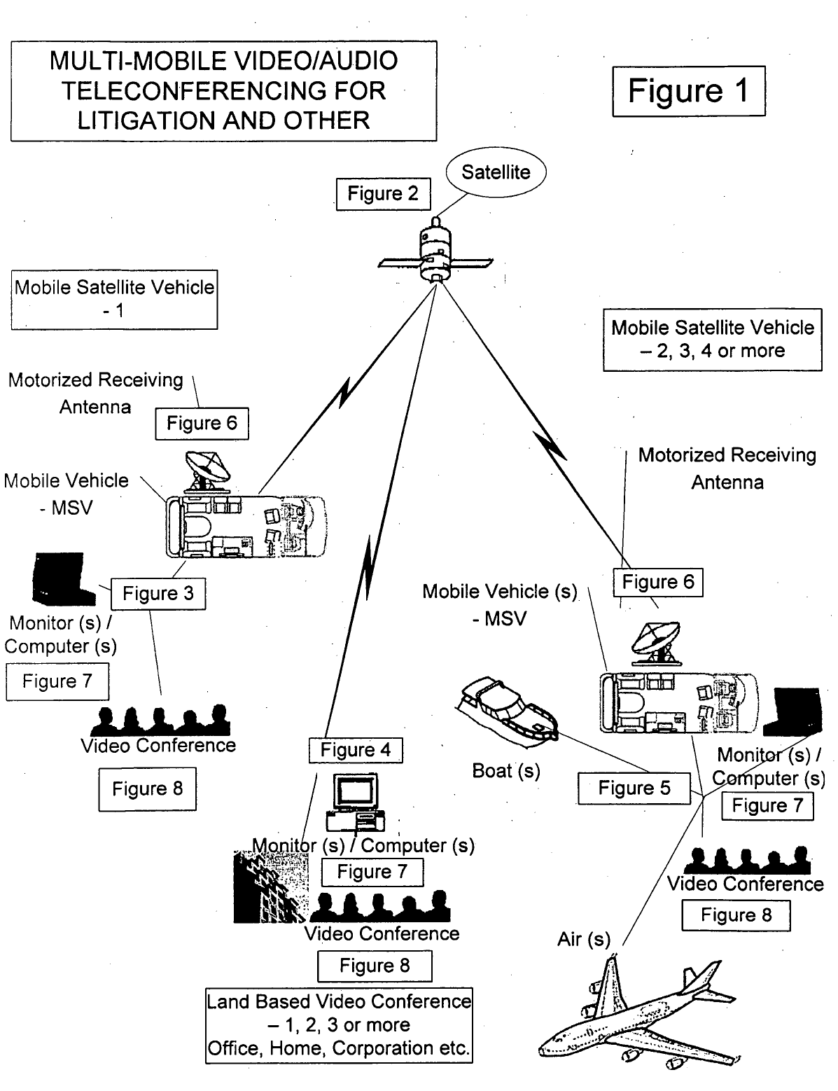

FIG. 1 is an aerial elevation view of the mobile satellite vehicle (MSV) and how it is arranged and configured in accordance with certain features, aspects and advantages of the present invention.

FIG. 2 is a representation of the Satellite with broadband communication link to each MSV, water based or water land system.

FIG. 3 is a representation of the Primary MSV linked to (other MSV's or water, air or land based systems) through video/audio broadband communication.

FIG. 4 is a representation of the land based broadband systems, which is linked with the primary broadband MSV.

FIG. 5 is a representation of the other video/audio options linked via broadband to primary broadband MSV.

FIG. 6 is a representation of the broadband MSV with satellite dish to communicate via satellite.

FIG. 7 is a representation of the monitor(s)/computer(s), which are linked to the video/audio broadband satellite communication signal.

FIG. 8 is a representation of the individual/group(s) of people interacting in broadband video/audio conference.

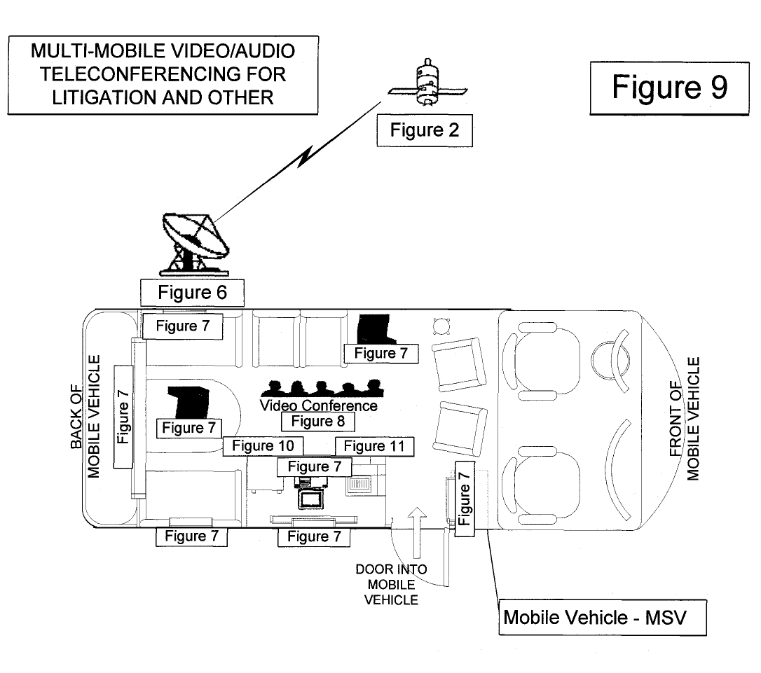

FIG. 9 is an aerial representation of the broadband mobile satellite vehicle (MSV) and how it is arranged and configured in accordance with certain features, aspects and advantages of the present invention. FIG. 9 also demonstrates how FIG. 2 (satellite) communicates with FIG. 6 (satellite dish on MSV). FIG. 7 are the monitors/computers, which were discussed above. FIG. 8 is as discussed above.

FIG. 10 is a representation of the computer system.

FIG. 11 is a representation of the fax/phone system.

1. A multi-mobile satellite vehicle (MSV) video/audio broadband teleconferencing system (FIG. 1) comprising: a motorized land vehicle or MSV (FIG. 9) with a 8-10 passenger compartment having seats, which are positioned in the passenger compartment to view the various monitors; a video/audio source that generates video/audio signals that are received and transmitted; monitors to show the video/audio signals, fax system, phone systems, E-Mail and several computer monitoring system(s). This overall system enhances collaboration between or among individuals who are separated by distance and for mobile (movable) satellite teleconferencing throughout the world.

2. Principal among the invention's goals is to replace face to face communication with a mobile broadband environment, which can be connected with other mobile broadband vehicles, or with water based broadband systems, broadband air based systems and/or with land based broadband stationary systems (i.e. from buildings, offices, conventions, etc.), to facilitate communication and information sharing which would have normally occurred if all participants were face to face. Prior videoconferencing systems did not provide this high video/audio resolution and at best, only provided a partial solution to the challenges of distant meetings, because of the lack of broadband communication and real time transfer of video/audio. Non-verbal communication can be missed without broadband video/audio signals and may be critical to an effective exchange of information. Research has demonstrated that non-verbal communication is over 90% of total communication and without the ability to observe/focus on key non-verbal components during inter-communications; it can inhibit efficient/effective communication, which could potentially lead to diminished profit and potentially serious consequences.
